(19) United States
(12) Patent Application Publication
(10) Pub. No.: US 2009/0132191 A1
(43) Pub. Date: May 21, 2009

(54) SYSTEM AND METHOD FOR ZERO RESETTING OF A MEASURING MACHINE

(75) Inventors: CHIH-KUANG CHANG, Tu-Cheng (TW); HUA-WEI YANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/198,325

(22) Filed: Aug. 26, 2008

(30) Foreign Application Priority Data
Nov. 15, 2007 (CN) 200710202562.4

(51) Int. Cl. G01B 1/00; G06F 19/00

(52) U.S. Cl. 702/87; 33/502

(57) ABSTRACT

A method for zero resetting of a measuring machine is provided. A zero-reset instruction is received. A zero-reset direction S1 of a movable arm and a position where the limit switch is fixed on the shaft is set as a first trigger position. The zero-reset instruction is executed. A first feedback pulse from the limit switch is received. A zero-reset direction S2 of the movable arm is set if the movable arm has reached the first trigger position. A position of a reference mark on a raster ruler fixed on the movable arm is set as a second trigger position. The zero-reset instruction is executed again. A second feedback pulse from a reader fixed on the movable arm is received. If the movable arm has reached the second trigger position, the zero resetting ends.

### BACKGROUND

1. Field of the Invention

Embodiments of the present disclosure relate to a system and method for zero resetting of a measuring machine.

2. Description of Related Art

Product quality is an important factor in improving the competitiveness of an enterprise. A prototype is usually made, inspected, and tested before a product is mass-produced. Computers have been introduced in the measuring process, and the accuracy of measurements has greatly improved. A measuring machine such as a three-dimensional measuring machine or a coordinate measuring machine (CMM) controlled by a computer, is commonly used to measure the dimensions of the prototype. The prototype is placed on a measuring area of the CMM. A movable arm with a charge-coupled device collects images of the prototype. The collected images are used for measuring the prototype.

However, the typical method of zero resetting counters of measuring machines is not accurate because only one trigger position is used. When the shaft is very long, the speed of zero resetting is very slow. Additionally, if there is any interference, such as electromagnetic interference from the servomotor, zero resetting may be inaccurate.

Therefore, an accurate system and method for zero resetting of a measuring machine is desired to overcome the above-described shortcomings.

### SUMMARY

In one aspect, the aforementioned needs are satisfied by a system for zero resetting a measuring machine includes a control card, a computer, and a measuring machine. The measuring machine has three shafts. Each shaft has a movable arm and a limit switch fixed on the shaft corresponding to a first trigger position. Each movable arm includes a reader and a raster ruler having a reference mark corresponding to a second trigger position. The control card includes a receiving module, a setting module, an executing module and a detecting module. The receiving module is configured for receiving a zero-reset instruction from the computer, and receiving a first feedback pulse from the limit switch when the movable arm stops. The setting module is configured for setting a zero-reset direction S1 of the movable arm, setting a zero-reset direction S2 of the movable arm, setting the first trigger position; and setting a position of the second trigger position. The executing module is configured for executing the zero-reset instruction. The detecting module is configured for detecting if the movable arm has reached the first trigger position according to the first feedback pulse. The receiving module is further configured for receiving a second feedback pulse from the reader when the movable arm stops after the executing module executes the zero-reset instruction again. The detecting module is further configured for detecting if the movable arm has reached the second trigger position according to the second feedback pulse.

Other objects, advantages and novel features of the present disclosure will become more apparent from the following detailed description of the embodiments when taken in conjunction with the accompanying drawings.

### BRIEF DESCRIPTION OF THE DRAWINGS

FIG. 1 is a schematic block diagram of one embodiment of a system for zero resetting a measuring machine, the system, including a computer, a control card, and a measuring machine;

FIG. 2 is a schematic diagram illustrating one embodiment of a shaft of the measuring machine;

FIG. 3 is a block diagram of one embodiment of the control card of the system of FIG. 1;

FIG. 4 is a flowchart of one embodiment of making preparations before zero resetting a measuring machine;

FIG. 5 is a flowchart of one embodiment of a method for zero resetting a measuring machine;

### DETAILED DESCRIPTION OF CERTAIN INVENTIVE EMBODIMENTS

The components in the drawings are not necessarily drawn to scale, the emphasis instead being placed upon clearly illustrating the principles of at least one embodiment. In the drawings, like reference numerals designate corresponding parts throughout the various views.

### Definition of Terms:

In order to describe the embodiments conveniently, the following technical terms are defined below.

Open loop: an open loop circuit of a servo;

Closed loop: a closed loop circuit of a servo;

Hard limit: a stop position of a movable arm that is set by a limit switch;

Soft limit: a programmed stop position of a movable arm;

Initial position: when a measuring machine is powered on, the measuring machine is at or returns to an initial reference position whose three dimensional coordinates are usually designated as (0, 0, 0).

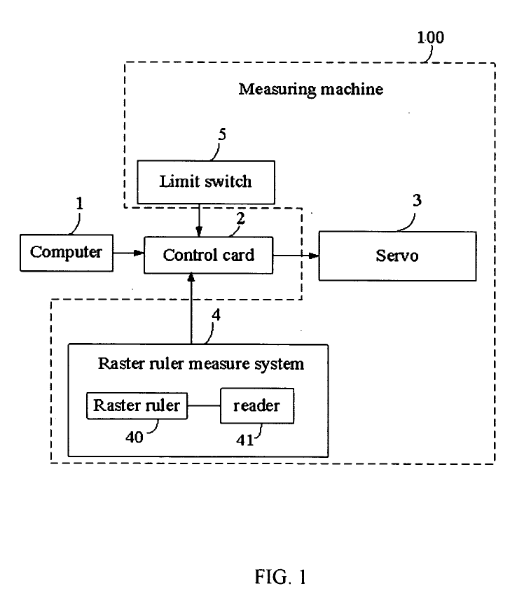

FIG. 1 is a schematic diagram of one embodiment of a system for zero resetting a measuring machine (hereinafter, “the system”). The system typically includes a computer 1, a control card 2, and a measuring machine 100. The measuring machine 100 has a servo 3, and a raster ruler measuring system 4. The measuring machine has an x-shaft, a y-shaft, and a z-shaft, each with a movable arm (not shown) and a limit switch 5. The movable arm of each shaft zero resets in turn. The computer 1 is configured for sending a zero-reset instruction to the control card 2, using a protocol such as RS232 or TCP/IP.

The servo 3 drives the movable arms (not shown in FIG.1) to move on each shaft of the measuring machine 100.

The raster ruler measuring system 4 includes a raster ruler 40 and a reader 41, each of which is fixed on the movable arm. The reader 41 reads data on the raster ruler 40 and outputs a feedback pulse to the control card 2, when the movable arm moves. There are one or more reference marks 204 on the raster ruler 40.

The limit switch 5 connects to an input/output port (I/O port) of the control card 2 via a signal wire. The limit switch 5 may be a photoelectric limit switch, a mechanical limit switch, or any other type of limit switch. In this embodiment, the limit switch 5 is a photoelectric limit switch.

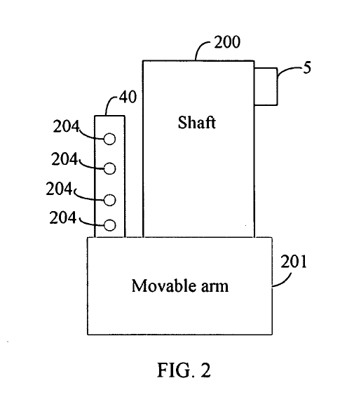

FIG. 2 is a schematic diagram illustrating one embodiment of a shaft of the measuring machine. The movable arm 201 moves along the shaft 200. A first trigger position of the movable arm 201 corresponds to where the limit switch 5 is fixed on the shaft 200. The raster ruler 40 is fixed on the movable arm. A second trigger position of the movable arm 201 corresponds to where a reference mark is on the raster ruler 40. The reference mark is one of the reference marks nearest to the limit switch 5.

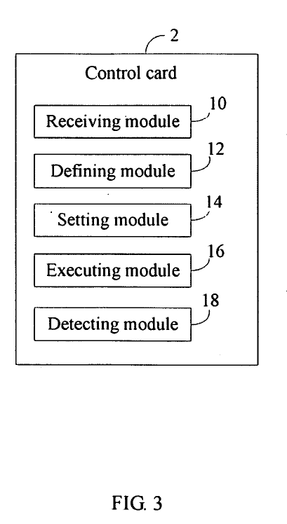

FIG. 3 is a block diagram of one embodiment of the control card of the system of FIG. 1 comprising software function modules. In one embodiment, the order of the zero reset actions of the shafts is z-shaft, x-shaft, and y-shaft. The software function modules may be used to implement certain functions. In one embodiment, the software function modules include a receiving module 10, a defining module 12, a setting module 14, an executing module 16, and a detecting module 18. It may be understood that one or more specialized or general purpose processors (not shown) in the control card 2 may be used to execute the software function modules 10, 12, 14, 16 and 18.

The receiving module 10 is configured for receiving a zero-reset instruction from the computer 1.

The defining module 12 is configured for defining variables. These variables include a servo status value, a hard limit state, a soft limit state, a movable arm speed, a limit switch status value, and a raster ruler reference mark status value. The servo status value identifies if the servo is in the closed loop state. The soft limit state and the hard limit state each include a valid state and an invalid state of the movable arm. The movable arm speed identifies whether the movable arm is in motion or at rest. The limit switch status value may be true if the movable arm has reached a position of the limit switch 5, or false if the movable arm has not reached a position of the limit switch 5. The raster ruler reference mark status value may be true if the movable arm has reached a position corresponding to where the one of the reference marks 204 nearest the limit switch 5, or false if the movable arm has not reached the position corresponding to where the one of the reference marks 204 nearest the limit switch 5.

The setting module 14 is configured for setting zero-reset parameters, for example, setting the soft limit state and the hard limit state as invalid, and setting a first offset of the initial position of the shaft as zero. If the first offset of the initial position is set as zero, the movable arm is unable to move after reaching the limit switch 5.

The setting module 14 is also configured for setting a zero-reset direction S1 of the movable arm of the z-shaft, setting a position of the limit switch 5 fixed on the z-shaft as a first trigger position, and setting a state value of a zero resetting flag. The state value 0 means that the zero resetting has not been completed. The state value 1 means that the zero resetting has been completed.

The executing module 16 is configured for executing the zero-reset instruction from the computer 1.

The detecting module 18 is configured for detecting if the movable arm has stopped according to the movable arm speed. For example, if the movable arm speed is substantially zero, the movable arm has stopped.

The receiving module 10 is also configured for receiving a first feedback pulse from the limit switch 5 when the movable arm stops.

The detecting module 18 is also configured for detecting if the movable arm has reached the first trigger position according to the first feedback pulse. In one embodiment, if the first feedback pulse is 1 (high level), the movable arm has reached the first trigger position. If the first feedback pulse is 0 (low level), the movable arm has not reached the first trigger position. If the movable arm stops but has not reached the first trigger position, the executing module 16 executes the zero-reset instruction again.

The setting module 14 is also configured for setting a zero-reset direction S2 of the movable arm of the z-shaft, setting a second offset of the initial position, and setting a second trigger position. The zero-reset direction S2 is opposite the zero-reset direction S1. The second offset may be a positive number or a negative number. The positive number is a distance that the movable arm moves in the S2 direction after the movable arm reaches at the limit switch 5. The negative number is a distance that the movable arm moves in the S1 direction after the movable arm reaches at the limit switch 5.

The receiving module 10 is also configured for receiving a second feedback pulse from the reader 41 when the movable arm stops.

The detecting module 18 is also configured for detecting if the movable arm reaches the second trigger position according to the second feedback pulse. In one embodiment, if the second feedback pulse is 1 (high level), the movable arm has reached the second trigger position. If the second feedback pulse is 0 (low level), the movable arm has not reached the second trigger position. If the movable arm stops but has not reached the second trigger position, the executing module 16 executes the zero-reset instruction again.

The detecting module 18 is further configured for detecting if all the shafts have returned to their respective initial positions. In one embodiment, if the x-shaft and y-shaft have not performed the zero-resetting yet, the x-shaft and y-shaft may do the movement in turn.

The setting module 18 is further configured for setting parameters after all the shafts have returned to their respective initial positions. The parameters include a limit to a distance the movable arms move on the shafts, the soft limit state, the hard limit state, and the value of the zero resetting flag. The setting module 18 sets the soft limit state and hard limit state as valid and sets the value of the zero resetting flag as 1.

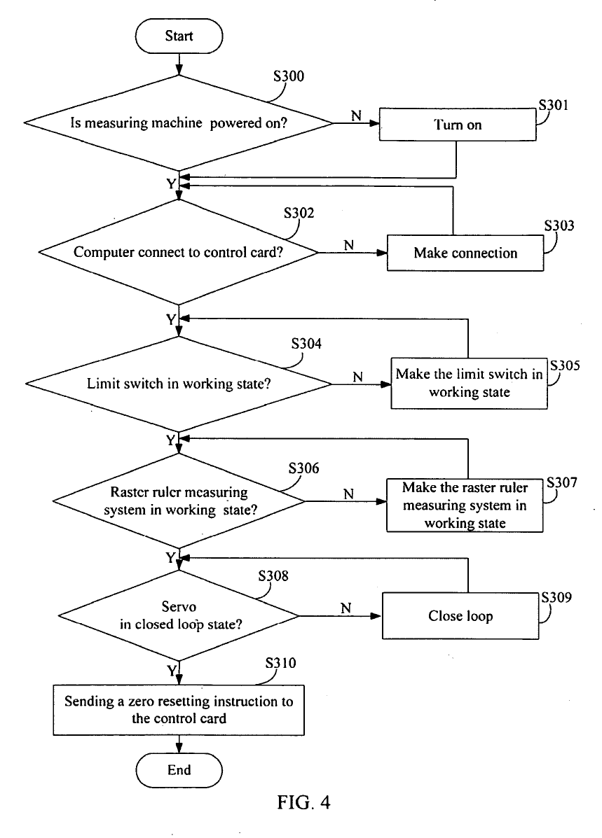

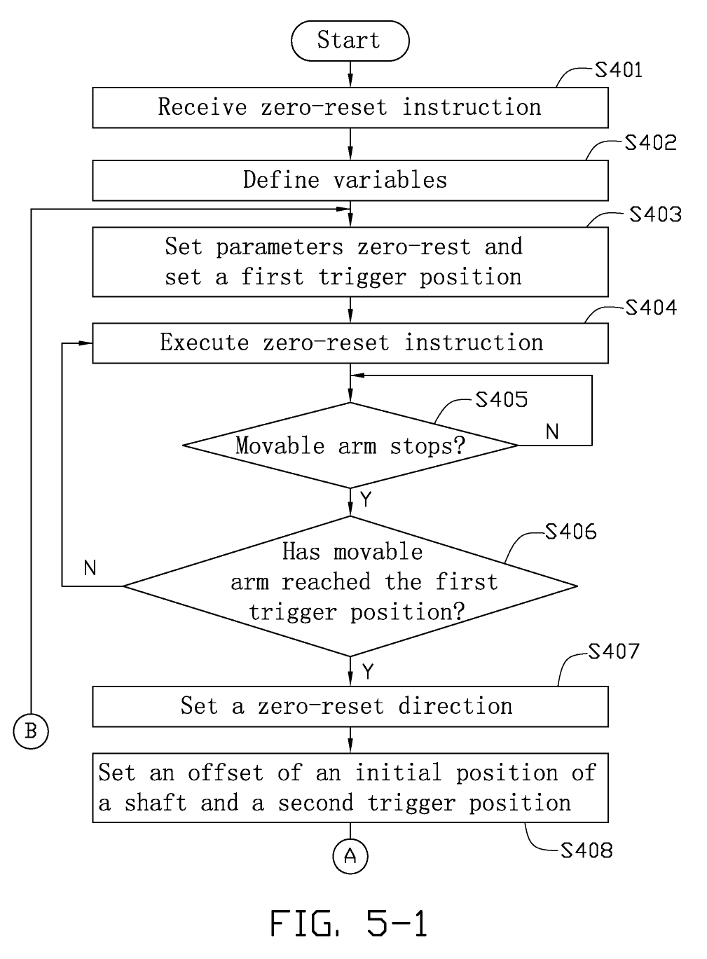

FIG. 4 is a flowchart of one embodiment of making preparations before zero-resetting a measuring machine. The computer 1 checks the state of the measuring machine before the measuring machine begins the zero-resetting, in order to ensure the safety and reliability of the measuring machine. Depending on the embodiment, additional blocks may be added, others removed, and the ordering of the blocks may be changed. In a block S300, the computer 1 checks whether the measuring machine is in a power-on state or a power-off state. In a block S301, if the measuring machine is in the power-off state, the measuring machine is powered.

In a block S302, the computer 1 detects if connected to the control card 2 of the measuring machine.

In a block S303, if the control card 2 is not connected to the computer 1, the computer 1 connects to the control card 2.

In a block S304, the computer 1 checks if the limit switch 5 is in a working state.

In a block S305, if the limit switch 5 is not in the working state, the user may switch the limit switch 5 to the working state.

In a block S306, the computer 1 checks if the raster ruler measuring system 4 is in a working state.

In a block S307, if the raster ruler measure system 4 is not in the working state, the user may switch the raster ruler measure system 4 to the working state.

In a block S308, the computer 1 detects if the servo 3 is in a closed loop state.

In a block S309, if the servo 3 is in an opened loop state, the user may close the loop so that the servo is in the closed loop state.

In a block S310, the computer 1 sends a zero-reset instruction to the control card 2.

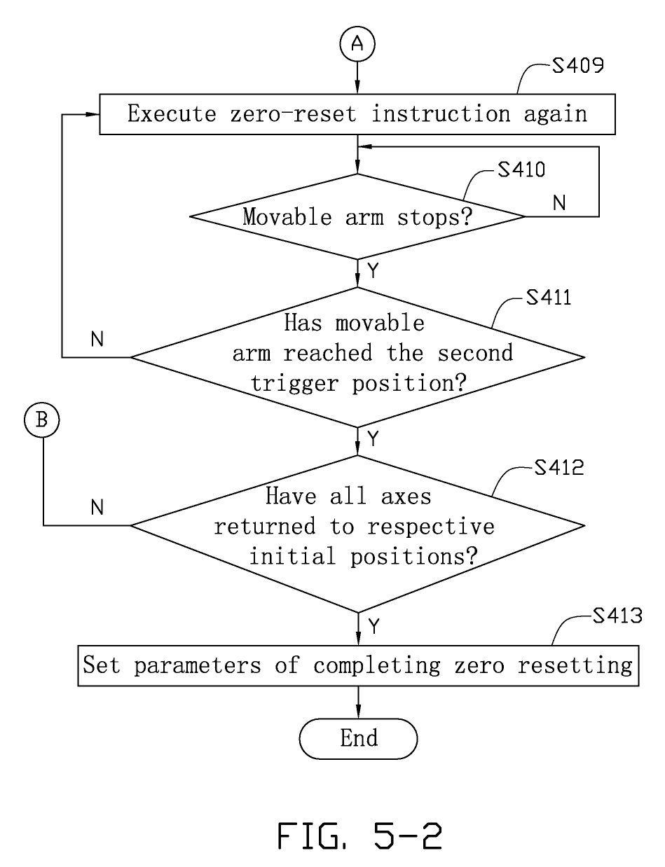

FIG. 5 is a flowchart of one embodiment of a method for zero resetting a measuring machine. Depending on the embodiment, in FIG. 5, additional blocks may be added, others removed, and the ordering of the blocks may be changed.

In a block S401, the receiving module 10 receives a zero-reset instruction from the computer 1.

In a block S402, the defining module 12 defines variables, such as the servo status value, the hard limit state, the soft limit state, the movable arm speed, the limit switch status value, and the raster ruler reference mark status value.

In a block S403, the setting module 14 sets zero-reset parameters, for example, the setting module 14 sets the soft limit state and the hard limit state as invalid, and sets a first offset of the initial position of the measuring machine as zero.

In a block S404, executing module 16 executes the zero-reset instruction from the computer 1.

In a block S405, detecting module 18 detects if the movable arm has stopped according to the movable arm speed. If the movable arm is in motion, the flow may move to the block S405. Otherwise if the movable arm stops, the flow may move to the block S406.

In a block S406, the receiving module 10 receives a first feedback pulse from the limit switch 5. The detecting module 18 detects if the movable arm has reached the first trigger position according to the first feedback pulse. If the movable arm has stopped but not reached the first trigger position, the flow may move to the block S404.

In a block S407, if the movable arm reached the first trigger position, the setting module 14 sets a zero-reset direction S2 of the movable arm of the z-shaft. The zero-reset direction S2 is opposite the zero-reset direction S1.

In a block S408, the setting module 14 sets a second offset of the initial position of the z-shaft and sets a second trigger position.

In a block S409, the executing module 16 executes the zero-reset instruction again.

In a block S410, the detecting module 18 detects if the movable arm has stopped. If the movable arm has not stopped, the flow may return to the block S410. Otherwise if the movable arm has stopped, the flow may move to the block S411.

In a block S411, the receiving module 10 receives a second feedback pulse from the reader 41. The detecting module 18 detects if the movable arm reaches the second trigger position according to the second feedback pulse. If the movable arm stops but not reached the second trigger position, the flow may return to the block S409. If the movable arm has reached the second trigger position, the flow may move to the block S412.

In a block S412, the detecting module 18 detects whether all the shafts have returned to their respective initial positions. If there is any movable arm of one shaft having not performed the zero-resetting, the flow may return to the block S402 and do the zero-resetting of the next shaft. In one embodiment, if the x-shaft and y-shaft have not performed the zero-resetting yet, the x-shaft and y-shaft may do the movement in turn

In a block S413, the setting module 14 sets parameters after all the shaft have returned to their respective initial positions. The parameters include a limit to the distance the movable arms move on the shafts, the soft limit state, the hard limit state, and the value of the zero resetting flag. The setting module 18 sets the soft limit state and the hard limit state as valid and sets the value of the zero resetting flag as 1, the procedure goes to end.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for zero resetting of a measuring machine, the system comprising:
a computer;
a measuring machine, the measuring machine having three shafts, each shaft having a movable arm and a limit switch fixed on the shaft corresponding to a first trigger position, wherein each movable arm comprises a reader and a raster ruler having a reference mark corresponding to a second trigger position;
a control card comprising:
a receiving module configured for receiving a zero-reset instruction from the computer, and receiving a first feedback pulse from the limit switch when the movable arm stops;
a setting module configured for setting a zero-reset direction S1 of the movable arm, setting a zero-reset direction S2 of the movable arm, setting the first trigger position, and setting the second trigger position;
an executing module configured for executing the zero-reset instruction;
a detecting module configured for detecting if the movable arm has reached the first trigger position according to the first feedback pulse;
wherein the receiving module is further configured for receiving a second feedback pulse from the reader when the movable arm stops after the executing module executes the zero-reset instruction again; the detecting module is further configured for detecting if the movable arm has reached the second trigger position according to the second feedback pulse.

2. The system of claim 1, wherein the control card further comprises a defining module configured for defining variables, the variables including a limit switch status value for identifying if the movable arm has reached the first trigger position, and a raster ruler reference mark status value for identifying if the movable arm has reached the second trigger position.

3. The system of claim 1, wherein the zero-reset direction S2 is opposite the zero-reset direction S1.

4. The system of claim 1, wherein the setting module is further configured for setting a soft limit state and a hard limit state of the moveable arm as invalid and setting an offset of an initial position of the shaft as zero.

5. The system of claim 4, wherein the detecting module is further configured for detecting if each movable arm has returned to an initial position; the setting module is further configured for setting the soft limit state and the hard limit state of each movable arm as valid if each movable arm has returned to the initial position.

6. The system of claim 1, wherein the second trigger position corresponds to one of the reference marks nearest to the limit switch.

7. A method for zero resetting of a measuring machine, the method comprising:
(a) receiving a zero-reset instruction by a control card sent from a computer connected to the control card;
(b) setting a zero-reset direction S1 of a movable arm of a shaft of the measuring machine, and setting a first trigger position corresponding to where a limit switch is fixed on the shaft;
(c) executing the zero-reset instruction by the control card;
(d) receiving a first feedback pulse sent from the limit switch when the movable arm stops;
(e) detecting if the movable arm has reached the first trigger position according to the first feedback pulse;
(f) setting a zero-reset direction S2 of the movable arm if the movable arm has reached the first trigger position, and setting a second trigger position corresponding to where a reference mark is on a raster ruler fixed on the movable arm;
(g) executing the zero-reset instruction again by the control card;
(h) receiving a second feedback pulse from a reader fixed on the movable arm when the movable arm stops; and
(i) detecting if the movable arm has reached the second trigger position according to the second feedback pulse; if the movable arm has reached the second trigger position, the zero resetting ends.

8. The method of claim 7, further comprising: defining variables, the variables including a limit switch status value for identifying if the movable arm has reached the first trigger position, and a raster ruler reference mark status value for identifying if the movable arm has reached the second trigger position, after block (a) and before block (b).

9. The method of claim 7, wherein the zero-reset direction S2 is opposite the zero-reset direction S1.

10. The method of claim 7, wherein the block (b) further comprises:
setting a soft limit state and a hard limit state of the movable arm as invalid and setting an offset of an initial position of the shaft as zero.

11. The method of claim 10, further comprising:
detecting if each movable arm has returned to an initial position; and
setting the soft limit state and the hard limit state of each movable arm as valid if each movable arm has returned to the initial position.

12. The method of claim 7, wherein the second trigger position corresponds to one of the reference marks nearest to the limit switch.

13. A medium having stored instructions for zero resetting of a measuring machine, the medium, when executed by a control card, causes the control card to:
(a) receiving a zero-reset instruction by a control card sent from a computer connected to the control card;
(b) setting a zero-reset direction S1 of a movable arm of an shaft of the measuring machine, and setting a first trigger position corresponding to where a limit switch is fixed on the shaft;
(c) executing the zero-reset instruction by the control card;
(d) receiving a first feedback pulse sent from the limit switch when the movable arm stops;
(e) detecting if the movable arm has reached the first trigger position according to the first feedback pulse;
(f) setting a zero-reset direction S2 of the movable arm if the movable arm has reached the first trigger position, and setting a second trigger position corresponding to where a reference mark is on a raster ruler fixed on the movable arm;
(g) executing the zero-reset instruction again by the control card;
(h) receiving a second feedback pulse from a reader fixed on the movable arm when the movable arm stops; and
(i) detecting if the movable arm has reached the second trigger position according to the second feedback pulse; if the movable arm has reached the second trigger position, the zero resetting ends.
